(19) United States
(12) Patent Application Publication
(10) Pub. No.: US 2015/0154659 A1
(43) Pub. Date: Jun. 4, 2015

(54) SYSTEM AND METHOD FOR DISPLAYING TRANSITIONAL MOBILE ADS DURING NETWORK PAGE DOWNLOAD LATENCY TIME

(71) Applicant: Yahoo! Inc., Sunnyvale, CA (US)

(72) Inventor: Beverly HARRISON, Palo Alto, CA (US)

(73) Assignee: Yahoo! Inc., Sunnyvale, CA (US)

(21) Appl. No.: 14/094,803

(22) Filed: Dec. 3, 2013

(51) Int. Cl. G06Q 30/02

(52) U.S. Cl. CPC G06Q 30/0277

(57) ABSTRACT

An electronic computer appliance, method, and computer program product are provided for providing a user of a mobile electronic device with a predetermined message during a communication network page loading latency time. The method comprises pre-caching the predetermined message; detecting the beginning of a page loading latency time; displaying the predetermined message on the mobile electronic device during the page loading latency time; and supplanting the predetermined message with a page that had been loaded during the page loading latency time.

### FIELD OF THE ART

The present subject matter generally relates to the field of network communication, such as Internet communication. The disclosure pertains to providing downloaded content to a user.

### BACKGROUND

When a user accesses a communication network, such as the Internet, the user access generally takes the form of user requests for various types of information. The user request for information is generally entered on an appliance such as a computer, tablet, smart telephone, etc., through a software application such as a web browser or native mobile application. In response to such a user request, the information is downloaded, where it may be viewed by the user on the appliance, in a window or other user interface display application.

In general, there is a finite latency time period between (i) the time the user initiates the user request (such by clicking or typing a “Send” commend after typing out the information request, and (ii) the time, at the conclusion of downloading, at which the information is actually displayed on the user's appliance.

While that latency time period is elapsing, the user's attention generally remains on the appliance, as he or she waits for the requested information to download. If other information were to be displayed on the appliance during that latency time period, there is a high likelihood that the other information would capture the user's attention. Thus, a party seeking to place information before the user, such as an advertiser, might take advantage of the opportunity for displaying the other information to the user during the latency time period.

### SUMMARY

An electronic appliance is provided for enabling a user to communicate and obtain digital information over a communication network, and for providing a user of the appliance with a predetermined message during a page loading latency time. An embodiment of the appliance comprises memory, allocated to serve as a pre-cache for the predetermined message; a user input interface, for allowing the user to enter a request to download a requested item of online content over the communication network; a detector for detecting a page loading latency time which commenced when the user enters the download request; and a display output controller for displaying the predetermined message on the mobile electronic device during the page loading latency time; wherein the display of the predetermined message is supplanted with the requested and downloaded item of online content.

A method is provided for providing a user of a mobile electronic device with a predetermined message during a communication network page loading latency time. An embodiment of the method comprises pre-caching the predetermined message; detecting the beginning of a page loading latency time; displaying the predetermined message on the mobile electronic device during the page loading latency time; and supplanting the predetermined message with a page that had been loaded during the page loading latency time.

A computer program product is provided, for directing an electronic computer appliance to provide a user of the electronic computer appliance with a predetermined message during a communication network page loading latency time. The computer program product comprises a non-transitory computer readable medium; and computer program code, provided on the non-transitory computer-readable medium. The computer program code directs the electronic computer appliance to perform the activities of pre-caching the predetermined message; detecting the beginning of a page loading latency time; displaying the predetermined message on the mobile electronic device during the page loading latency time; and supplanting the predetermined message with a page that had been loaded during the page loading latency time.

Further features and advantages of embodiments of the subject matter disclosed herein, as well as the structure and operation of preferred embodiments, are described in detail below with reference to the accompanying exemplary drawings. The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### DESCRIPTION OF DRAWINGS

In the following drawings like reference numbers are used to refer to like elements. Although the following figures depict various examples of the invention, the invention is not limited to the examples depicted in the figures set forth herein.

FIG. 1 is a flowchart showing a method for showing a transitional message, according to an embodiment.

FIG. 2 is a flowchart showing a method for showing a transitional message, according to another embodiment.

FIG. 3 is a flowchart showing, in greater detail, an embodiment according to the element 105 of FIGS. 1 and 2.

FIG. 4 is a block diagram of a network communications environment within which embodiments of the present subject matter may be practiced.

FIG. 5 is a system block diagram of user computer appliance as per an embodiment of the present subject matter.

### DETAILED DESCRIPTION

The above-mentioned needs are met by a method, computer program product and system for providing a user of a network communication device, such as a mobile electronic device, with a predetermined message during a page loading latency time. The following detailed description is intended to provide example implementations to one of ordinary skill in the art, and is not intended to limit the invention to the explicit disclosure, as one of ordinary skill in the art will understand that variations can be substituted that are within the scope of the invention as described.

### Embodiments for Display During Latency Time

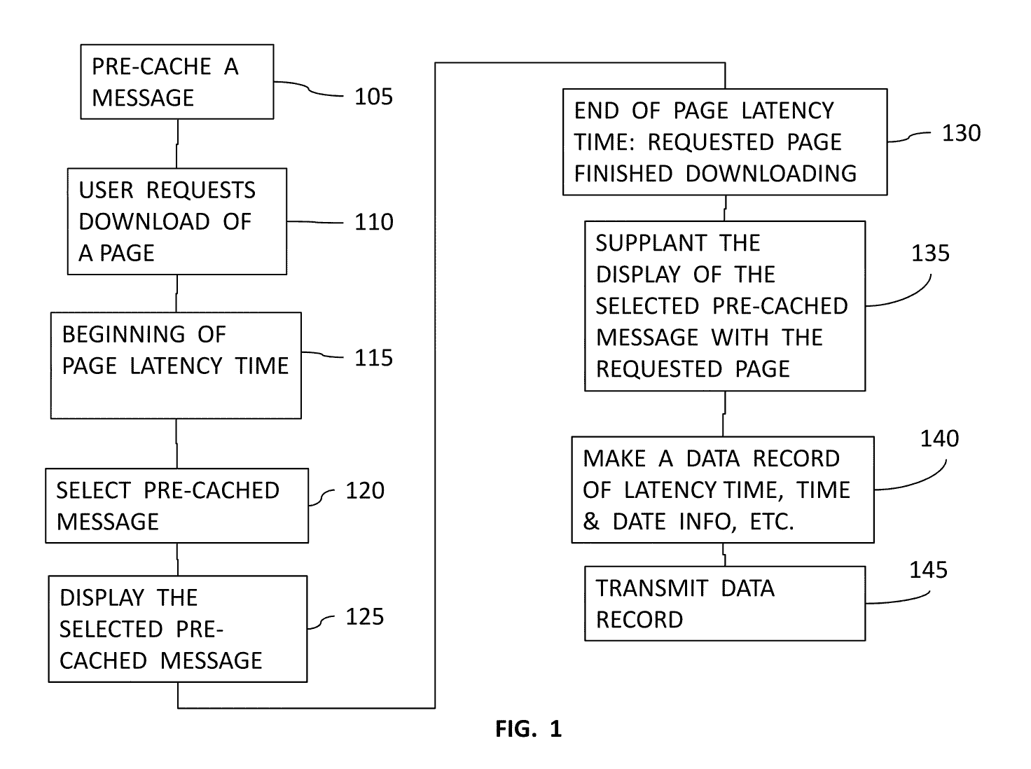

FIG. 1 is a flowchart showing an embodiment of a method for temporarily providing predetermined information to a user of a network appliance, during a latency time while content, requested by the user, is being downloaded for display.

A display controller maintains a pre-cache of messages that can be displayed. Here, the term “message” or “predetermined message” is used broadly, to refer to any content that might be of interest to the user, such as an advertisement, a still image, an audio or a video clip that may relate to the user's interests, a written document such as a message from another party, an advertisement from a merchant, etc. The term “content” is also intended to cover, broadly, such a variety of information or material.

In the method of FIG. 1, a message such as one of those just described, is pre-cached (105). Pre-caching involves storing the message in a readable cache, library, etc. The pre-cached message may be associated with a particular user or group of users (e.g., based on a demographic category, relationship within a social network, purchase history, existing business relationship, etc.). The user appliance or network account may include identities and/or profiles for one or more users, and these user identities and profiles may provide information that is associated with a given pre-cached message, and which is drawn upon to determine which pre-cached message is to be displayed. Further details about obtaining messages for pre-caching, downloading or otherwise acquiring them, associating them with particular users, storing them in the pre-cache, and accessing them for display will be discussed below.

In the course of using the network appliance, the user may request (110) download of content, such as a Web page, online document, image, audio or video, etc. The user does so in any suitable fashion, such as through a Web browser. Thus, there begins a finite latency time period (115) during which the content downloads. It is anticipated that the user will watch the appliance, in the expectation that the download latency time will be reasonably short, however finite, and that the requested content will soon appear.

In accordance with an embodiment, during the download latency time, a pre-cached message is selected (120) and displayed (125). The selection 120 may be done based on the user identity and profile information, or according to a non-user-specific schedule, in which a given pre-cached message is displayed in correlation with a certain chronological time, or in which a set of pre-cached messages take turns being displayed when opportunities to display them arise. Display of these pre-caches messages may be visual, auditory, or a combination of both.

It may also be possible to estimate in advance the download time for the user-requested content, and choose a pre-cached message for display based on the estimated length of time it will be displayed. For instance, a pre-cached video clip may be chosen based on how long it takes to run, and whether the estimated download time is long enough that the pre-cached clip will have time to run to completion. If the pre-cached message is a piece of text for the user to read, then the length of time a typical user will require to read through the pre-cached message may be estimated, and the pre-cached message text may be chosen of the download latency time is expected to be long enough for the user to finish reading the pre-cached text message.

Eventually, the user-requested content finishes downloading (130). At that time, the requested content supplants the selected pre-cached message, and is displayed (135). In an embodiment, the pre-cached message may be displayed, while also displaying a status indicator reflecting the on-going progress of the page download. Occasionally, page downloads, refreshes or reloads fail altogether. In such cases, it is possible to maintain the pre-cached message, for instance, as a floating ad, while still displaying the error messages indicating the page load failed.

As a result, the download latency time period, during which the user's attention is likely focused on the appliance, as the user waits for the download, is taken up by the pre-cached message. The pre-cached content may be something the user is interested in, but may, in an embodiment, be an advertisement, for bringing a product or service to the user's attention.

When the download has supplanted the display of the pre-cached content, a data record may be created (140). The data record may include information such as the duration or length of time the pre-cached message was displayed, and time and date stamps representing the real-time beginning and/or end of the time period during which the pre-cached message was displayed. and the data record may additionally contain other salient user profile information, such as the user's identify, the user's web activity before or during the download latency time period, or information regarding the user's purchasing history that was used as a basis for choosing the choosing the pre-cached message to be displayed for the user's viewing.

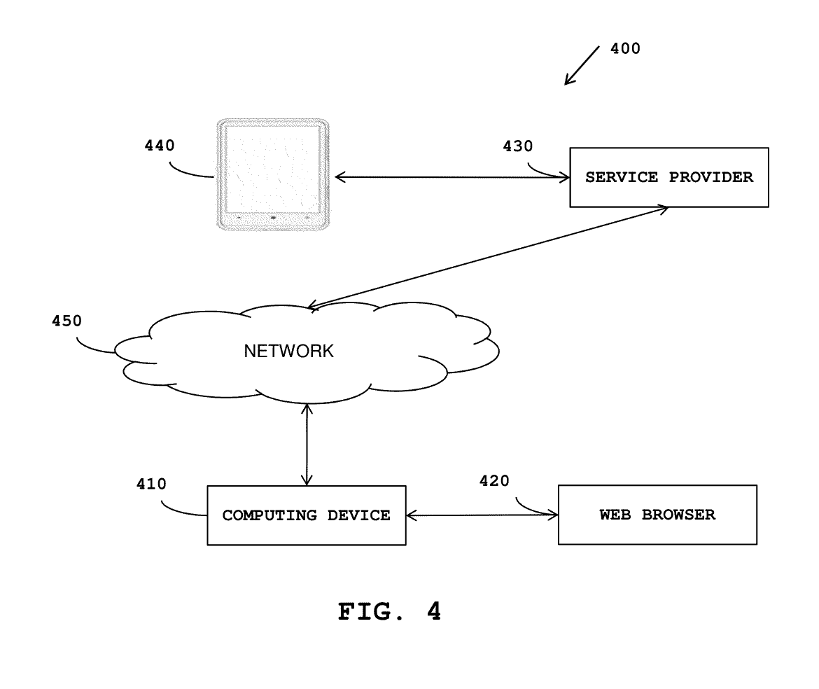

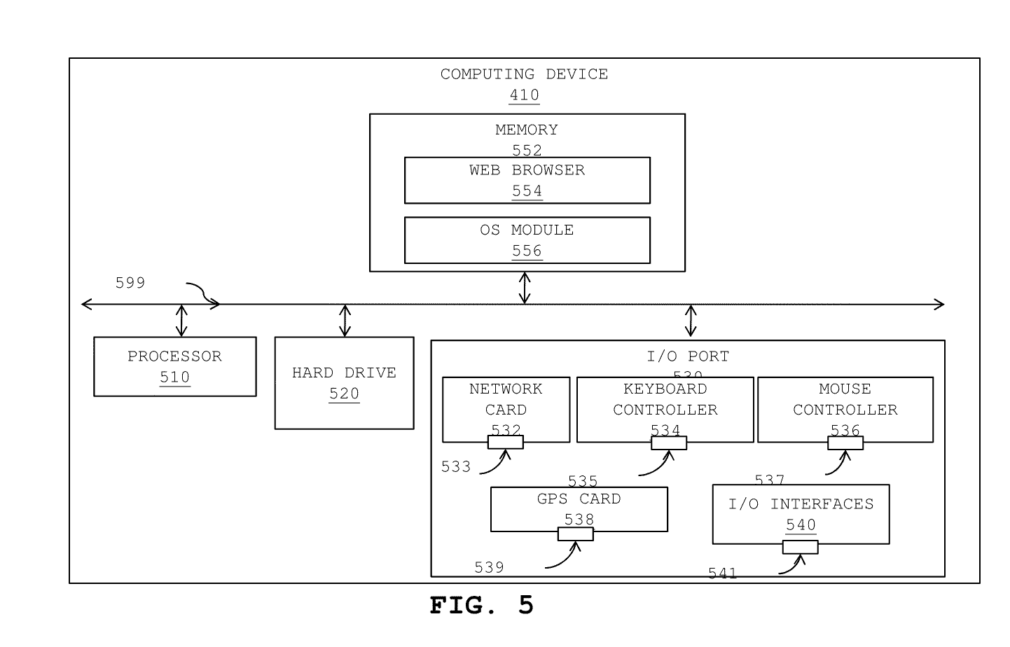

This data record about usage of pre-cached content may be transmitted (145) at some future point in time, via a network connection, to a remote network device. That remote device may, for instance, be a service provider or backend service, which will use the information in the data record to enable tracking or billing for such displayed content. The discussion that follows, in connection with the block diagram of FIG. 4, gives additional details about a remote device (shown as 440 in FIG. 5), which may receive such a transmitted data record.

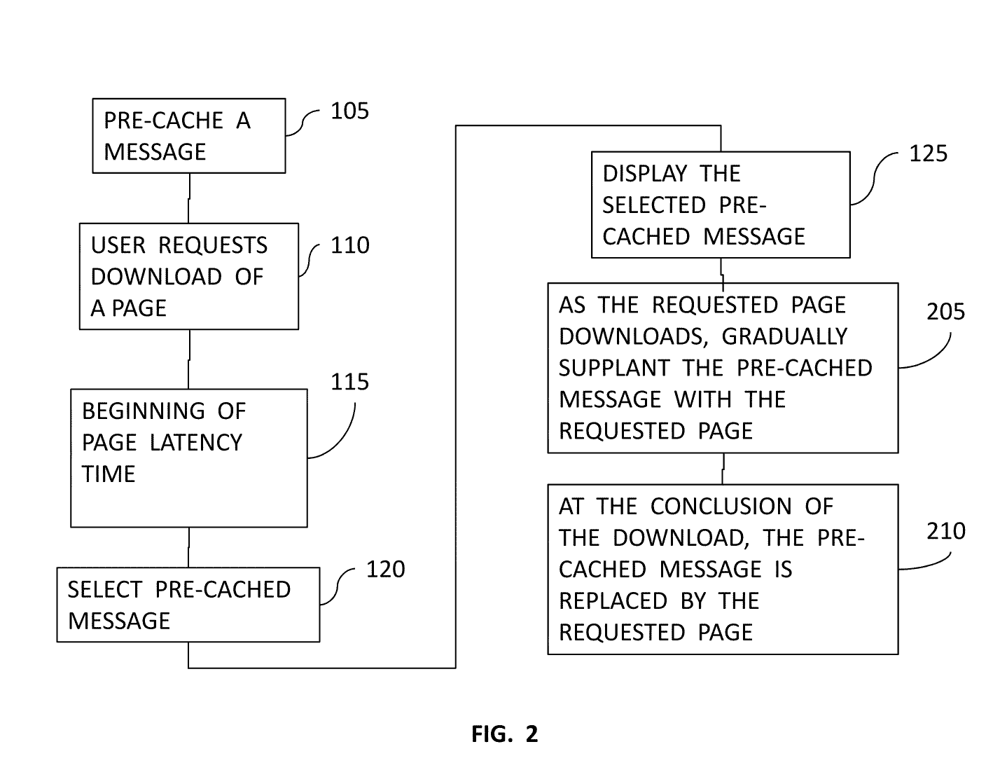

FIG. 2 illustrates another embodiment, which has some elements in common with that of FIG. 1. Accordingly, similar elements are numbered similarly.

The embodiment of FIG. 2 differs from that of FIG. 1 in that, as the requested page downloads, it gradually supplants (205) the displayed pre-cached message. Thus, at the conclusion of the download, the pre-cached message is entirely replaced (210) by the requested page. This embodiment may be suitable for pre-cached messages that may usefully be viewed in part, as the requested page gradually supplants it. For instance, a still image may convey useful information to the user even while it is partially supplanted. Alternatively, the pre-cached message may resize automatically in part or in its entirety based on available space. Also, if a pre-cached piece of written text is gradually supplanted from the top down, it may be the that user, reading the pre-cached text, will be able to keep up with the download of the requested page, and read the pre-cached text, line by line, before the already-read lines are supplanted.

### Embodiment for Downloading Pre-Cache Messages

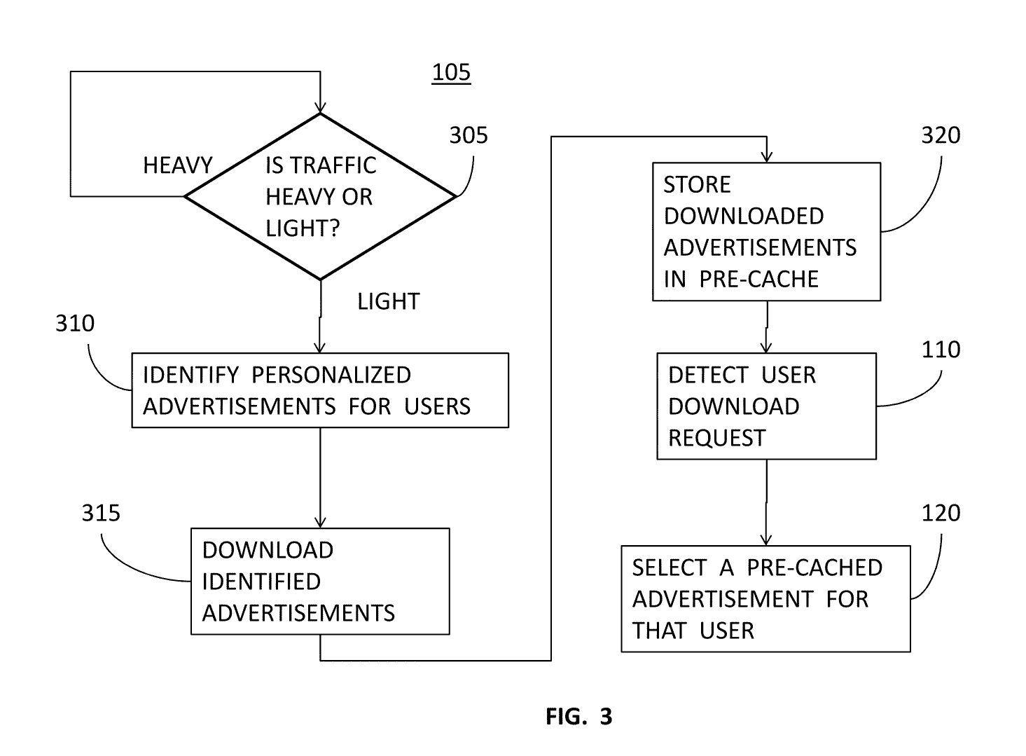

FIG. 3 is a flowchart showing, in more detail, an embodiment of the element 105 of FIGS. 1 and 2. In those embodiments, the element 105 generally shows pre-caching messages.

In FIG. 3, details of an embodiment for pre-caching are shown. In this embodiment, it is assumed that pre-cached messages are themselves downloaded from over the network, and are then stored in a pre-cache for display later, when the user requests a download.

Initially, a check is made (305) as to whether upload and/or download traffic, between the user appliance and the network, or remote servers, etc., on the network, is heavy or light. The distinction between heavy and light may be made according to any suitable standard, such as the throughput capacity of the link between the appliance and the network, the size of messages that potentially could be download for pre-caching, the amount of traffic between the appliance and the rest of the network, or between remote sites over the network, the estimated amount of time it would take to download a message for pre-caching, the amount of CPU time on the user appliance currently being taken up by its own on-board activities, etc.

Taking any or all of the above criteria into consideration, a decision is made whether the traffic is light enough that a pre-cache message download may be undertaken, or is heavy enough that it should not be undertaken. If traffic is considered too heavy to undertake a pre-cache message download, then the illustrated method, checks again for traffic heaviness or lightness, for instance after processing other activities (not shown) for a suitable period of time.

It will be understood, also, that checking for traffic heaviness or lightness may optionally be omitted in some embodiments. In such other embodiments, the pre-cache message download may take place independently of network traffic heaviness or lightness, for instance according to a pre-set schedule, or in response to a request either from the user appliance or from a remote network server or other appliance.

Assuming there is to be a pre-cache message download, advertisements that may be personalized, or otherwise suitable, for particular users are identified (310). The identification of such advertisements may be made based on the user identity and profile information mentioned above, or based on data mining records for the user's past spending transactions, tastes or habits, etc. While advertisements are here discussed, it will be understood that other types of messages may be chosen for pre-cache downloading, such as images, video, audio, written documents, etc., based on factors such as the user's interest level, as derived from the stored user identity and profile information, from selections chosen by the user him- or herself, etc.

It will also be understood that messages that have already been downloaded may be updated or refreshed by the same process or processes here described.

In an embodiment in which an outside party, such as an advertiser, seeks to make downloaded, pre-cached advertisements available for temporary viewing by the user during download latency times.

The identified advertisements, documents, images, audio, video clips, etc., are downloaded (315) from their remote server repositories, etc., to the user appliance. The downloading may be done in a manner transparent to the user, without any sort of user notification, prompting or monitoring. The downloading may also be done while network traffic remains low, and may be slowed down or postponed during intervals of high network traffic, so that the user's activities are not noticeably slowed down due to the downloading.

The downloaded pre-cache messages are then stored (320), on board the user appliance or locally accessible thereby. The storage can be in a portion of system memory allocated for the pre-cache. The pre-cache storage may be accompanied by user information such as the identity of a particular user for whom the pre-cache message is intended, or by metadata to identify the intended user, subject matter, etc., or by a separate directory, which contains the user information, etc., and references the pre-cache message itself by a suitable means such as a pointer.

Once pre-cache messages have been downloaded and pre-cached, the user appliance goes about its other activities, until a user download is requested (110). This is generally as described in the embodiments of FIGS. 1 and 2. When the system detects such a download request, it proceeds to select (120) a pre-cached message, such as an advertisement, for temporary display during the download latency period. Selecting a pre-cached message may be done based on factors not specific to the user making the download request, such as those described above: pre-scheduling, a cycle of messages that take turn being displayed, selection based on the amount of time required for effective display of the pre-cache message versus the anticipated latency time, etc. Alternatively, the selection may be based on the identity of the user, taking into consideration his/her interests, spending habits, past history of online activities, etc.

### An Application: Advertising for Revenue Generation

Embodiments as described herein, as well as other embodiments foreseeable to persons of ordinary skill in the art based on the present disclosure, may provide an advantageous opportunity to put information before the user, during a time period when the user's attention might otherwise be underutilized. One opportunity, in particular, is that afforded to advertisers.

Pre-loaded and pre-cached personalized advertisements are displayed during the time it takes to fetch and reload user-requested pages on a user appliance such as a mobile device. Thus, they take advantage an opportunity to re-use the screen background, which might otherwise just show a blank screen and a spinner or other pending activity icon or animation. During this period, the user is not otherwise occupied, but is likely to be paying attention as he-she waits for the download. This is particularly true for mobile devices, in which the user may have to wait longer for a download, or for reloading or refreshing pages. On mobile devices, these activities often take longer, based on type of network and network traffic.

Pre-caching the advertisements does not impact network performance in any way the user would notice and object to. Nonetheless, it provides system administrators with a new advertising revenue opportunity.

Advertisers may want their ads available for a circumscribed period of time, at a predictable cost. This can be accommodated in an embodiment where pre-fetching and local caching strategies are suitably used. For example, when a page with embedded ads (e.g., HomePage) is downloaded for pre-caching, a tag can be set, to indicate that these ads are to be retained in local memory for a specified time duration, which might be coded in the form of an expression such as <n>. Later the system rotates through a pre-cached collection of such tagged ads.

These ads can be refreshed periodically, such as daily, weekly, hourly, etc. Refreshing can be responsive to suitable events, such as whenever users load new property pages, or during periods of particularly low network usage/traffic times (e.g., in the middle of the night)

For pages that perform progressive page reloads, i.e., partial pages are sent and drawn as more data is downloaded to the user device, the ad could appear as a “floating” ad that is gradually moved from the top of the screen off the bottom as the downloaded user-requested page content gradually appears. Alternatively, such ads could dynamically resize all, or a portion of, their content to accommodate the progressive page download.

### Operating Environment

FIG. 4 is a block diagram illustrating a system for providing a user with communication network access and for displaying a predetermined message during a download latency time on a mobile device, in accordance with one embodiment.

The system 400 can implement the method described above. The system 400 includes a computing device 410 such as the user appliance discussed above, a web browser program 420 installed and functioning thereon, a service provider 430, and a remote device 440 in communication with a network 450 (for example, the Internet or a cellular network).

Examples of the computing device 410 include, but are not limited to, a Personal Computer (PC), a laptop or notebook computer, a tablet computer, a smart phone or Personal Digital Assistant (PDA), a smart appliance, an Internet television or any other suitable processor-based device that can display web pages.

The computing device 410 includes a display, a user input interface such as a keyboard and mouse, and runs a web browser 420. The web browser is a software application for retrieving, presenting and traversing information resources on the World Wide Web (WWW). The information resources are web pages, images, videos or other forms of content. The web browser can be a desktop web browser (for example, Internet Explorer, Mozilla, or Chrome), a mobile browser, or a web viewer built integrated into an application program. The web browser 420 could also be a native mobile application and would operate in a manner consistent with the description provided here.

The web browser 420 loads desired web pages for the user. The web pages can include textual information, digital images, video and static advertisements, and other digital assets.

The service provider 430, for example Yahoo! and Gmail, provides email services to users of the computing device 410 through the network 450. The email services enable users to send, receive and review email from corresponding web browsers. Examples of email services include, but are not limited to, Yahoo! Mail, Gmail, Hotmail and AOL Mail. The description presented here applies to other content types which the service provider 430 might provide; including, for example, news results, search query results, or video and music content.

The remote device 440 may be a server, etc., operated by an outside entity who has a desire to make certain information, such as advertisements, available to users, under circumstances in which the users will see the advertisements even though they may not have sought out the advertisements. The remote device 440 is connected to the service provider 430.

Generally as described in connection with FIG. 3, the remote device 440 downloads one or more pre-cache messages to be pre-cached on-board, or locally accessible to, the computing device 410.

The user of the computing device 410 opens the web browser 420 and requests download of an item of online content, such as a Web page, generally as described in connection with the element 110 of FIGS. 1 and 2. The computing device 410 consults the pre-cache, along with any instructions for selecting pre-cached messages as described in connection with the element 120 of FIGS. 1 and 2, and displays the selected pre-cached message as per the element 125.

The user-requested item of content proceeds to download over the network 450 to the computing device 410. When it has arrived, it is displayed in a manner such as that of elements 130 and 135 of the embodiment of FIG. 1, or the elements 205 and 210 of the embodiment of FIG. 2.

### Block Diagram of User Appliance—Computing Device

Additional embodiments of the computing device 410 are described in detail in conjunction with FIG. 5.

FIG. 5 is a block diagram illustrating an exemplary computing device, for example the computing device 410 in accordance with one embodiment. The computing device 410 includes a processor 510, a hard drive 520, an I/O port 530, and a memory 552, coupled by a bus 599.

The pre-cache described in connection with the above embodiments may, for instance, reside on the hard drive 520, or within the memory 552. The processor 510 may execute software program code, stored on the hard drive 520 or in the memory 552, for executing instructions to implement the functionality of embodiments such as those described above.

The bus 599 can be soldered to one or more motherboards. Examples of the processor 510 includes, but is not limited to, a general purpose processor, an application-specific integrated circuit (ASIC), an FPGA (Field Programmable Gate Array), a RISC (Reduced Instruction Set Controller) processor, or an integrated circuit. The processor 510 can be a single core or a multiple core processor. In one embodiment, the processor 510 is especially suited for processing demands of location-aware reminders (for example, custom micro-code, and instruction fetching, pipelining or cache sizes). The processor 510 can be disposed on silicon or any other suitable material. In operation, the processor 510 can receive and execute instructions and data stored in the memory 552 or the hard drive 520. The hard drive 520 can be a platter-based storage device, a flash drive, an external drive, a persistent memory device, or other types of memory.

The hard drive 520 provides persistent (long term) storage for instructions and data. The I/O port 530 is an input/output panel including a network card 532 with an interface 533 along with a keyboard controller 534, a mouse controller 536, a GPS card 538 and I/O interfaces 540. The network card 532 can be, for example, a wired networking card (for example, a USB card, or an IEEE 802.3 card), a wireless networking card (for example, an IEEE 802.11 card, or a Bluetooth card), and a cellular networking card (for example, a 3G card). The interface 533 is configured according to networking compatibility. For example, a wired networking card includes a physical port to plug in a cord, and a wireless networking card includes an antennae. The network card 532 provides access to a communication channel on a network. The keyboard controller 534 can be coupled to a physical port 535 (for example PS/2 or USB port) for connecting a keyboard. The keyboard can be a standard alphanumeric keyboard with 101 or 104 keys (including, but not limited to, alphabetic, numerical and punctuation keys, a space bar, modifier keys), a laptop or notebook keyboard, a thumb-sized keyboard, a virtual keyboard, or the like. The mouse controller 536 can also be coupled to a physical port 537 (for example, mouse or USB port). The GPS card 538 provides communication to GPS satellites operating in space to receive location data. An antenna 539 provides radio communications (or alternatively, a data port can receive location information from a peripheral device). The I/O interfaces 540 are web interfaces and are coupled to a physical port 541.

The memory 552 can be a RAM (Random Access Memory), a flash memory, a non-persistent memory device, or other devices capable of storing program instructions being executed. The memory 552 comprises an Operating System (OS) module 556 along with a web browser 554. In other embodiments, the memory 552 comprises a calendar application that manages a plurality of appointments. The OS module 556 can be one of Microsoft Windows® family of operating systems (for example, Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, IRIX64, or any version of Android.

The web browser 554 can be a desktop web browser (for example, Internet Explorer, Mozilla, Safari, or Chrome), a mobile browser, or a web viewer built integrated into an application program. In an embodiment, a user accesses a system on the World Wide Web (WWW) through a network such as the Internet. The web browser 554 is used to download the web pages or other content in various formats including HTML, XML, text, PDF, postscript, python and PHP and may be used to upload information to other parts of the system. The web browser may use URLs (Uniform Resource Locators) to identify resources on the web and HTTP (Hypertext Transfer Protocol) in transferring files to the web.

As described herein, computer software products can be written in any of various suitable programming languages, such as C, C++, C#, Pascal, Fortran, Perl, Matlab (from MathWorks), SAS, SPSS, JavaScript, AJAX, and Java. The computer software product can be an independent application with data input and data display modules. Alternatively, the computer software products can be classes that can be instantiated as distributed objects. The computer software products can also be component software, for example Java Beans (from Sun Microsystems) or Enterprise Java Beans (EJB from Sun Microsystems). Much functionality described herein can be implemented in computer software, computer hardware, or a combination.

Furthermore, a computer that is running the previously mentioned computer software can be connected to a network and can interface to other computers using the network. The network can be an intranet, internet, or the Internet, among others. The network can be a wired network (for example, using copper), telephone network, packet network, an optical network (for example, using optical fiber), or a wireless network, or a combination of such networks. For example, data and other information can be passed between the computer and components (or steps) of a system using a wireless network based on a protocol, for example Wi-Fi (IEEE standards 802.11, 802.11a, 802.11b, 802.11e, 802.11g, 802.11i, and 1802.11n). In one example, signals from the computer can be transferred, at least in part, wirelessly to components or other computers.

### CONCLUSION

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. An electronic appliance for enabling a user to communicate and obtain digital information over a communication network, and for providing a user of the appliance with a predetermined message during a page loading latency time, the appliance comprising:
memory, allocated to serve as a pre-cache for the predetermined message;
a user input interface, for allowing the user to enter a request to download a requested item of online content over the communication network;
a detector for detecting a page loading latency time which commenced when the user enters the download request; and
a display output controller for displaying the predetermined message on the mobile electronic device during the page loading latency time;
wherein the display of the predetermined message is supplanted with the requested and downloaded item of online content.

2. An electronic appliance as recited in claim 1, wherein pre-cached predetermined message is selected to coincide with user interest.

3. An electronic appliance as recited in claim 1, wherein the detector detects the beginning of a page loading latency time by detecting a user input command to the mobile electronic device, to perform one of (i) loading a user-selected page from the network, and (ii) refreshing a currently displayed page from the network.

4. An electronic appliance as recited in claim 1, wherein:
the page, loaded during the page-loading latency time, appears progressively, and
the display output controller supplants the predetermined message with the requested and downloaded item of online content by gradually displacing the predetermined message with the page, as the page is gradually download.

5. An electronic appliance as recited in claim 1, wherein the predetermined message is pre-cached along with a tag to indicate a time period during which the predetermined message is to remain cached for display during a page loading latency time.

6. An electronic appliance as recited in claim 1, wherein the predetermined message is received for pre-caching responsive to heaviness or lightness of network activity.

7. A method for providing a user of a mobile electronic device with a predetermined message during a communication network page loading latency time, the method comprising:
pre-caching the predetermined message;
detecting the beginning of a page loading latency time;
displaying the predetermined message on the mobile electronic device during the page loading latency time; and
supplanting the predetermined message with a page that had been loaded during the page loading latency time.

8. A method as recited in claim 7, wherein the pre-caching includes selecting the predetermined message to coincide with user interest.

9. A method as recited in claim 7, wherein the pre-caching includes pre-loading the predetermined message during a period of low network traffic which precedes the beginning of the page loading latency time.

10. A method as recited in claim 7, wherein the detecting the beginning of a page loading latency time includes detecting a user input command to the mobile electronic device, to perform one of (i) loading a user-selected page from the network, and (ii) refreshing a currently displayed page from the network.

11. A method as recited in claim 7, wherein:
the page, loaded during the page-loading latency time, appears progressively, and
the supplanting includes gradually displacing the predetermined message with the page, as the page progressively appears.

12. A method as recited in claim 7, wherein the pre-caching includes tagging the predetermined message with a time period during which the predetermined message is to remain cached for display during a page loading latency time.

13. A method as recited in claim 7, wherein the pre-caching is done responsive to heaviness or lightness of network activity.

14. A method as recited in claim 7, further comprising creating a data record containing the duration for which the pre-determined message was displayed, when in real time the pre-determined message was displayed, and user profile information.

15. A method as recited in claim 14, further comprising transmitting the data record over a network to a remote network device.

16. A computer program product for directing an electronic computer appliance to provide a user of the electronic computer appliance with a predetermined message during a communication network page loading latency time, the computer program product comprising:
a non-transitory computer readable medium; and
computer program code, provided on the non-transitory computer-readable medium, for directing the electronic computer appliance to perform the activities of:
pre-caching the predetermined message;
detecting the beginning of a page loading latency time;
displaying the predetermined message on the mobile electronic device during the page loading latency time; and
supplanting the predetermined message with a page that had been loaded during the page loading latency time.

17. A computer program product as recited in claim 16, wherein the pre-caching includes selecting the predetermined message to coincide with user interest.

18. A computer program product as recited in claim 16, wherein the pre-caching includes pre-loading the predetermined message during a period of low network traffic which precedes the beginning of the page loading latency time.

19. A computer program product as recited in claim 16, wherein the detecting the beginning of a page loading latency time includes detecting a user input command to the mobile electronic device, to perform one of (i) loading a user-selected page from the network, and (ii) refreshing a currently displayed page from the network.

20. A computer program product as recited in claim 16, wherein:
the page, loaded during the page-loading latency time, appears progressively, and
the supplanting includes gradually displacing the predetermined message with the page, as the page progressively appears.

21. A computer program product as recited in claim 16, wherein the pre-caching includes tagging the predetermined message with a time period during which the predetermined message is to remain cached for display during a page loading latency time.

22. A computer program product as recited in claim 16, wherein the pre-caching is done responsive to heaviness or lightness of network activity.

23. A computer program product as recited in claim 16, wherein a data record is created containing the duration for which the pre-determined message was displayed, when in real time the predetermined message was displayed, and user profile information.

24. A computer program product as recited in claim 23, wherein the data record is transmitted over a network to a remote network device.
